(19) United States
(12) Patent Application Publication
(10) Pub. No.: US 2003/0046201 A1
(43) Pub. Date: Mar. 6, 2003

(54) Method and system for creating e-marketplace operations

(75) Inventor: Adam Cheyer, Oakland, CA (US)

Correspondence Address: MORGAN LEWIS & BOCKIUS LLP, 1111 PENNSYLVANIA AVENUE NW, WASHINGTON, DC, 20004, US

(73) Assignee: Vert Tech LLC

(21) Appl. No.: 10/117,328

(22) Filed: Apr. 8, 2002

Related U.S. Application Data
(60) Provisional application No. 60/281,788, filed on Apr. 6, 2001.

(51) Int. Cl. G06F 17/60

(52) U.S. Cl. 705/35

(57) ABSTRACT

A system and method for implementing an open services market platform in a public or private electronic marketplace. The open services market platform includes a layered architecture that accelerates the development and customization of applications in a given marketplace and accommodates integration between multiple marketplaces and/or business partners. The open services market platform includes a collaboration layer and a service coordination layer. The collaboration layer facilitates multi-party collaboration and provides tools that permit business partners to define relationships among various programming interfaces. The service coordination layer enables business logic to be rapidly customized to meet an organization's evolving needs and facilitates in the selection of an optimal trading partner for a given task. Therefore, electronic marketplaces built with the open services market platform are easily developed and customized to meet the evolving needs of participants within the marketplace.

This application claims the benefit of U.S. Provisional Application No. 60/281,788, filed on Apr. 6, 2001.

### FIELD OF THE INVENTION

The present invention relates to an electronic marketplace and more particularly to electronic marketplaces that are developed with an open services market platform.

### BACKGROUND OF THE INVENTION

E-commerce activities are generally conducted in public or consortium marketplaces. In such environments, marketplace buyers, suppliers, and other appropriate entities must authenticate themselves and give assurances that they are legitimate trading partners before a transaction can occur between two or more parties. Moreover, parties to the transaction may also be required to prove that they are authorized to perform the transaction in the electronic marketplace. Most public marketplaces do not use customized business rules and knowledge to automate service brokering and coordination between participants. Therefore, as electronic services options expand, selecting the optimal trading partner in a marketplace becomes a complex task. Today electronic-business operations are generally complex and they involve numerous applications, information sources, services and participants that may be distributed throughout an extended enterprise. Such extended enterprises are usually made up of vast networks of internal and external divisions and partnerships.

To facilitate transactions between participants in extended enterprises, market analysts are beginning to emphasize the value of private electronic trading exchanges as a model that more adequately serves the needs of many businesses. A private trading exchange is an application platform on which a company/enterprise builds its trading interface to both suppliers and customers via an electronic network, preferably the Internet. Thus, the private trading exchange serves as a single integration point for all trading partners in a particular business and as a repository for strategic commerce-enabling applications. Generally, private trading exchanges also do not automate service brokering and coordination between participants.

Current approaches to cross-enterprise integration of private trading exchanges usually involve high development costs and generally result in rigidly created systems, whereby information formats programmed for exchanging messages between multiple business partners are difficult to change as the needs of the business partners evolve. Traditional “hard-coded” approaches to business software integration are usually not flexible enough to meet the evolving needs of complex global enterprises and marketplaces. Inter-enterprise integration also faces other technical challenges, such as integrating different information technology systems, business vocabularies and requirements, costs, and the length of application development, that prevent the integration of private trading exchanges.

What is needed, therefore, is a system and method that is adaptable to changing market conditions and that enable multiple enterprises to interact with overlapping groups of customers and suppliers by helping employees design, negotiate, buy, sell, and communicate over vast networks with numerous trading and business partners.

### SUMMARY OF THE INVENTION

The present invention provides a system and method for implementing an open services market platform in a public or private electronic marketplace. The open services market platform includes a layered architecture that accelerates the development and customization of applications in a given marketplace and accommodates integration between multiple marketplaces and/or business partners. The open services market platform includes a collaboration layer and a service coordination layer. The collaboration layer facilitates multi-party collaboration and provides tools that permit business partners to define relationships among various programming interfaces. The service coordination layer enables business logic to be rapidly customized to meet an organization's evolving needs and facilitates in the selection of an optimal trading partner for a given task. Therefore, electronic marketplaces built with the open services market platform are easily developed and customized to meet the evolving needs of participants within the marketplace.

Specifically in a preferred embodiment of the invention, the collaboration layer includes ontology-based business services vocabularies, mapping tools, and a business and service registry. The service coordination layer includes a business process engine and an automated brokering and service coordination tool. The ontology-based business services vocabularies provide trading partners with a common language that enables rapid integration of services, effective negotiation between market participants and cost-effective collaboration between trading partners and/or services. The mapping tools enable business partners to define the relationships among various programming interfaces and formats and the business and service registry enables addition and customization of trading partners and services. The business process engine enables dynamic customization of business logic to meet evolving needs of organizations and the automated brokering and service coordination tool facilitates in the selection of optimal trading partner by using customized business rules and knowledge.

The collaboration layer and a service coordination layer include several server-level components that are arranged in a three-tier hierarchy. The hierarchical layers include a presentation layer, a business logic layer, and a services layer. The presentation layer manages users' interfaces and interactions with the system; the business logic layer defines the functionality of a business application and specifies how individual functional components and external services communicate; the services layer provides mediated access to potentially distributed services across numerous communications protocols. More particularly, the services layer includes an ontology builder, a service registry, a service select wizard, a service coordination advisor, and a service execution engine.

The ontology builder aids the marketplace builder in constructing and modifying ontologies or trading vocabularies that are used to structure services and/or processes. The service registry is a directory of web-based services. The service select wizard enables a business analyst to specify requirements for how an appropriate service provider should be selected to accomplish a task in a business-process flow. The service coordination advisor is an extensible rule-based expert system that helps manage optimal business partner(s) selections and the service execution engine is a server that manages communications with remote business services.

Additional features and advantages of the invention will be set forth in the description that follows, and in part will be apparent from the description, or may be learned by practice of the invention. The objectives and advantages of the invention will be realized and attained by the system and method particularly pointed out in the written description and claims hereof as well as the appended drawings.

To achieve these and other advantages and in accordance with the purpose of the invention, as embodied and broadly described, the present invention provides a system for creating an electronic marketplace that enables inter-enterprise collaboration, integration and customization and accelerates system development. The system includes an open services market platform that comprises a collaboration layer having a common language and components for defining relationships among various programming interfaces and formats and enabling dynamic addition and editing of participants and services in the electronic marketplace, a service coordination layer having components for enabling rapid customization of business logic and automating brokering and service coordination among participants in the electronic marketplace, and a plurality of server level components that interface with the collaboration layer and the service coordination layer to deliver functions and services to participants of the electronic marketplace.

The invention also provides an open-services market-enabled electronic marketplace that enables inter-enterprise collaboration, integration and customization and accelerates system development. The marketplace includes a first component that provides trading partners in the electronic marketplace with an ontology-based language for rapid integration of services and effective negotiation and collaboration among trading partners and services; a second component that enables the trading partners to define relationships among various application programming interfaces and information formats; a third component that enables dynamic addition and editing of trading partners and services in the electronic marketplace; a business process engine that enables rapid customization of business logic in the electronic marketplace; a fourth component that facilitates in selecting at least one optimal trading partner; a fifth component that enables rapid customization of business logic and automates brokering and service coordination among participants in the electronic marketplace; and a plurality of server level components that interface with the first to fifth components to deliver functions and services to participants of the electronic marketplace.

The invention further provides an open-services market-enabled electronic marketplace that enables inter-enterprise collaboration, integration and customization and accelerates system development. The marketplace comprises a presentation layer for managing user interfaces in the electronic marketplace and users' interactions with the user interfaces; a business logic layer for defining the functionality of a business application in the electronic marketplace and for specifying how individual functional components of the business application communicate with external services; and a services layer for providing mediated access to potentially distributed services across numerous communication protocols.

The present invention also provides an open-services market-enabled electronic marketplace that enables inter-enterprise collaboration, integration and customization and accelerates system development. The marketplace comprises a presentation layer that manages user interfaces in the electronic marketplace and users' interactions with the user interfaces; a business logic layer that defines the functionality of a business application in the electronic marketplace and specifies how individual functional components of the business application communicate with external services; an ontology builder that is used to create and modify ontologies through which services, information and processes that are used in the electronic marketplace are structured; a service registry that is a dynamic directory of web-based services; a service publisher that is a wizard based tool for enabling providers of on-line commerce to dynamically register and administer descriptions of their capabilities within the electronic marketplace; a service coordination advisor that is rule-based expert system that encodes a trading partner's logic for how to do business with other trading partners and uses predefined rules and factors to help manage the selection of the at least one optimal trading partner; a service select wizard that is a user interface that enables a user to specify requirements for how an appropriate service provider in the electronic marketplace should be selected to accomplish a specific task, thereby enabling implementation of the service coordination advisor; and a service execution engine that manages communications with remote business services and uses predefined communication protocols to interact with trading partners selected by the service coordination advisor.

The invention also provides a method for facilitating interaction with an open services market-enabled electronic marketplace that enables inter-enterprise collaboration, integration and customization and accelerates system development. The method comprises the steps of registering a trading partner with the electronic marketplace; publishing, by the trading partner, services performed by the trading partner; mapping published services to application programming interfaces and information; providing a library of business processes; ensuring efficient execution of the business process to conform to specifications identified by a requesting participant of the electronic marketplace; providing services, to the trading partner, to create web portals and business application user interfaces; providing open application programming interfaces that enable dynamic discovery and inspection of services in the electronic marketplace; and providing protocols for interaction with services in the electronic marketplace.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

1 illustrates the layers of an open services market platform;

FIG. 2 illustrates the hierarchical layers in the open services market platform;

FIG. 3 illustrates components of the services layer;

FIG. 4 illustrates interactions within an open services market platform-enabled marketplace; and

FIG. 5 illustrates how services are defined and published in an open services market platform-enabled marketplace.

### DESCRIPTION OF THE PREFERRED EMBODIMENTS

Reference will now be made in detail to the preferred embodiments of the present invention, examples of which are illustrated in the accompanying drawings. The present invention described below extends the functionality of the inventive system and method for creating an electronic marketplace that incorporates an open services market platform.

The open services marketplace platform of the present invention is an enterprise-class infrastructure for constructing public and private electronic marketplaces. The open service marketplace platform implements private and public marketplaces by providing a network platform, preferably the Internet, for transactions designed for inter-enterprise collaboration. According to the inventive system, the open services marketplace platform enables multiple internal and external divisions in an organization to interact with overlapping groups of customers and/or suppliers and the open service market platform accelerates system development, integration, re-configuration, and/or customization.

FIG. 1 illustrates the layers of the open services market platform 100. In a preferred embodiment of the invention, open service market platform 100 includes a collaboration layer 102 and a service coordination layer 104. Collaboration layer 102 includes ontology-based business services vocabularies 106, mapping tools 108 and a business and service registry 110. Service coordination layer 104 includes a business process engine 112 and an automated brokering and service coordination tool 114. Ontology-based business services vocabularies 106 provide trading partners with a common language that enables rapid integration of services over vast networks, effective negotiation between business partners and cost-effective collaboration between trading and business partners and/or services. Mapping tools 108 enables business partners to define the relationships among various application programming interfaces and information formats. Business and service registry 110 enables dynamic addition of trading partners and services and promotes flexible substitution of providers to meet any given situation. Business process engine 112 enables business logic to be rapidly customized to meet the changing needs of an organization and automated brokering and service coordination tool 114 facilitates in the selection of optimal trading partner(s) by using customized business rules and domain-specific knowledge.

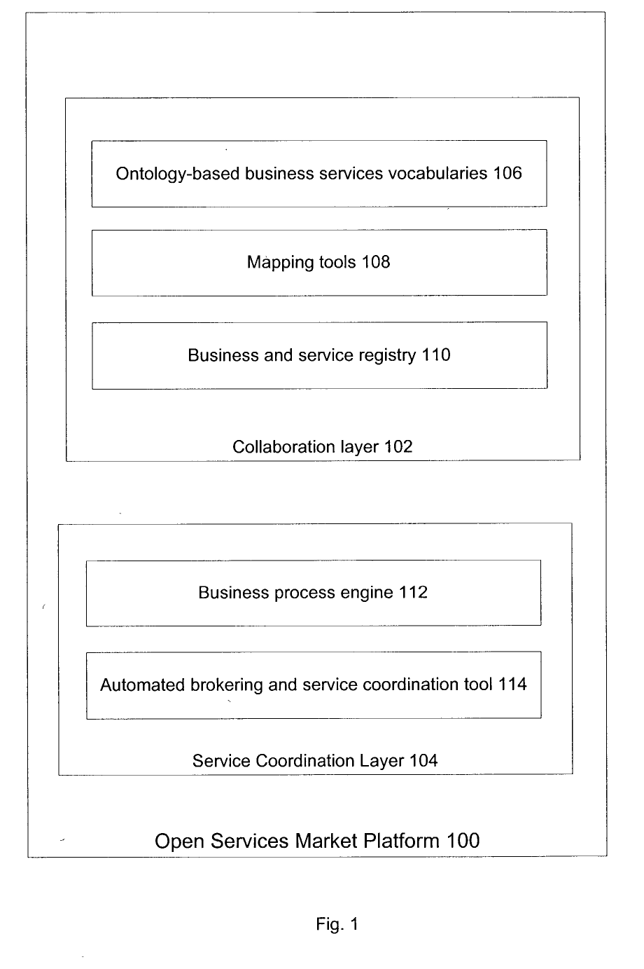

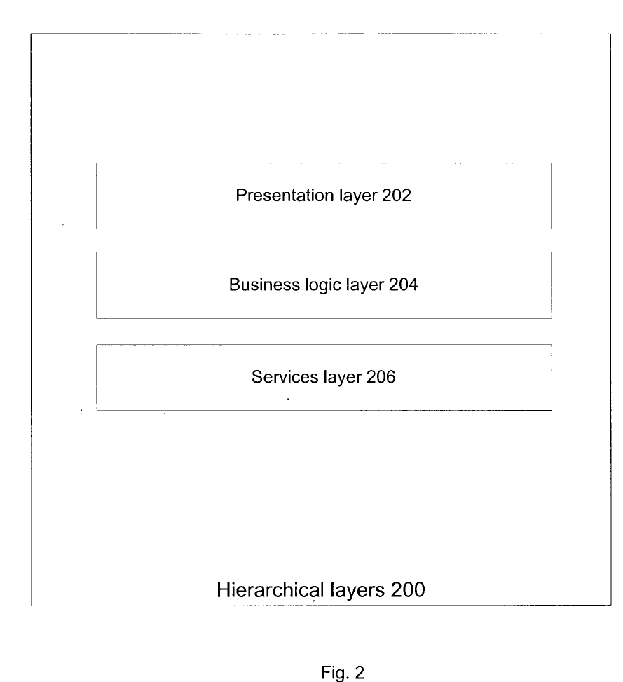

Open services market platform 100 includes various server level component that interface with collaboration layer 102 and service coordination layer 104 to effectively deliver marketplace functions and services. The server level components are arranged in a three-tier hierarchy to effectively deliver marketplace functionality. FIG. 2 illustrates hierarchical layers 200 of the server level components. The hierarchical layers include a presentation layer 202, a business logic layer 204 and a services layer 206. Each layer is implemented using a well-defined interface.

Presentation layer 202 manages users' interfaces and interactions with the system. Business logic layer 204 defines the functionality of a business application and specifies how individual functional components communicate with external services. Services layer 206 provides mediated access to potentially distributed services across numerous communications protocols.

Specifically in a preferred embodiment of the invention, a marketplace builder uses the presentation layer to define the look and feel of a user interface, such as a screen sequence, with only a loose coupling to the business logic of the underlying marketplace. Business logic layer 204 provides multiple techniques for implementing the functionality behind the graphical user interfaces of the marketplace. For example, to promote enhanced flexibility, user interactions with a user interface can be tied to logic specified in a programming language, for example, as Java code and/or linked to business processes stored in a business process library. Therefore, by using business logic layer 204, multiple processes can be dynamically and rapidly created and customized for specific situations and/or user interactions.

Business logic layer 204 also enables the marketplace to delegate to external services providers, which were previously defined in a service repository, execution of events caused by a user interaction. This enables an application using open services market platform 100 to define business rules that select an appropriate partner for a specific context and/or user interaction. It also enables a business enterprise to reconfigure business partners over time without having to “re-code” business processes to accommodate a new business partners' application programming interfaces. Therefore, instead of binding a business process logic to a known system through hard-coded application programming interfaces, an enterprise may delegate the execution of an action to a set of external service providers that were previously defined in a service repository.

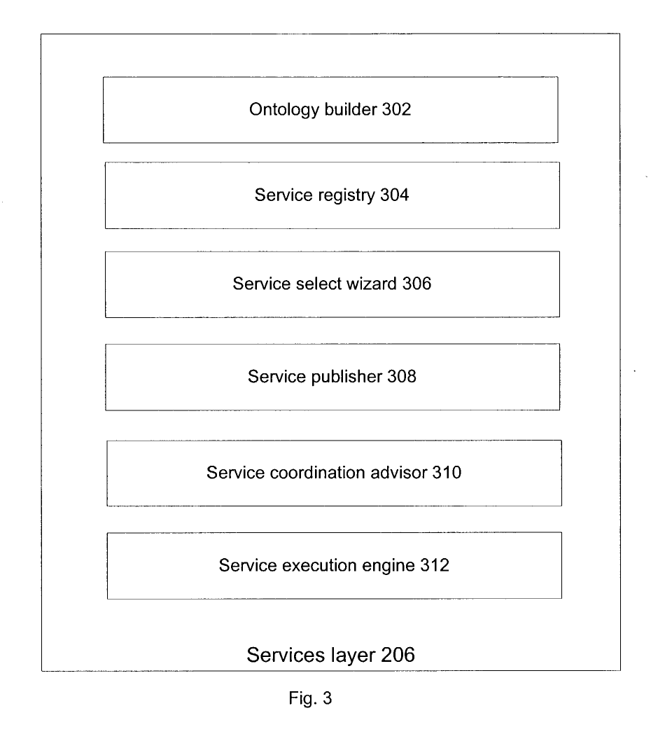

Services layer 206 enables business logic layer 204 to access and/or integrate with component services defined by the marketplace or by external business partners. FIG. 3 illustrates components of services layer 206. Services layer 206 includes an ontology builder 302, a service registry 304, a service publisher 306, a service coordination advisor 308, a service select wizard 310 and a service execution engine 312. Ontology builder 302 aids the marketplace builder in constructing and modifying ontologies or trading vocabularies through which services and processes are structured. Service registry 304 is a directory of web-based services. Trading partners use service publisher 306 to register with the electronic marketplace and describe their services. Service coordination advisor 308 is an extensible rule-based expert system that helps manage optimal business partner(s) selections. While designing a business-process flow, service select wizard 310 enables the business analyst to specify requirements for how an appropriate service provider should be selected to accomplish a task in the business-process flow. Service execution engine 310 is a server that manages reliable and scalable communications with remote business services.

Specifically, ontology builder 302 enables cross-enterprise business operations to communicate, negotiate and transact business by using predefined standards. These standards are used to define the formats and semantics for the information that is to be exchanged in accomplishing business tasks. The open services market platform model provides a data structure for storing information about business partners, the services they provide, constraints and properties that describe these services, and the rules for managing the services and business partners' relationships. Open services market platform 100 also provides an initial ontology and mapping tools 108 for creating relationships between open services market platform 100 ontology and existing standards or application programming interfaces. This permits automatic translation between various formats.

Service registry 304 is used by an enterprise in the marketplace to store information about business partners and the services they provide. Service registry 304 is dynamic; therefore, new business partners and/or services can be added or information associated with a specific business partner may be updated at any time. Service publisher 306 is a wizard-based tool that enables providers of business-to-business commerce or other on-line commerce to dynamically register and administer descriptions of their capabilities within one or more open services market-enabled marketplaces.

By using service publisher 306, a service provider creates increased sales channels for services provided in public and/or private business-to-business marketplaces. Additionally, mapping tools in service publisher 306 enable the service provider to maintain one application programming interface specification in its preferred format and then map this application programming interface specification to many different marketplaces' formats. Thus, the ontology and mapping tools in the open services market platform enable an associated marketplace to provide a single application programming interface to many business partners, each with their own potentially different native interfaces.

Service coordination advisor 308 determines which of the available service providers is best suited to a current situation, as defined by many factors, for example, context, process requirements, cost, time, and reliability. Therefore, service coordination advisor 308 is an easy-to-extend business rule engine that encodes an enterprise's logic for how it does business with its partners. Service coordinator advisor 308 combines multiple information sources in order to determine the optimal trading partner to fulfill a specific service. Service coordinator advisor 308 figures out which service providers are best suited to a current situation, by using varying business factors, such as cost and time. To make recommendations about which provider to choose, advisor 308 uses a decision-theoretic algorithm to combine the inputs across multiple dimensions from a potentially distributed set of knowledge sources called decision experts.

Service select wizard 310 is a user interface that enables implementation of service coordination advisor 308. While designing a process flow, the business analyst uses service select wizard 310 to specify requirements for how the appropriate service provider should be selected to accomplish a task in the process flow. Using this application, the business analysis specifies the type of service to fulfill, general and specific constraints about the tasks to be accomplished, and preferences about individual service providers or decision experts. After supplying this information to advisor 308, a list of recommended providers, ranked in order of suitability, is displayed through service select wizard 310. For each recommended provider, the user may view various levels of explanations about how the recommendation was obtained. The user may then explore additional information for the recommended provider to evaluate the decision. Using this interactive process the user may set up different scenarios and view the resulting responses. Once sufficient research has been conducted, the user may select a preferred provider at design time and may specify whether advisor 308 should perform a run-time analysis to optimize the process or to handle exceptions. An example of handling an exception is if the user is trying to select a shipper and a preferred shipper has no trucks available, an alternate shipper may be automatically selected to meet the requirements identified by the user. In one embodiment of the invention, run-time decisions can be automatically enacted by advisor 308, or a mode can be set to request a confirmation notification before executing any tasks that depend on run-time decisions.

Once service coordination advisor 308 chooses an optimal business partner for an activity, service execution engine 312 uses predefined communication protocols to interact with the contracted partner. Specifically, service execution engine 312 accepts a request message from service coordination advisor 308 in the format specified by the marketplace ontology and translates both the request and any subsequent response.

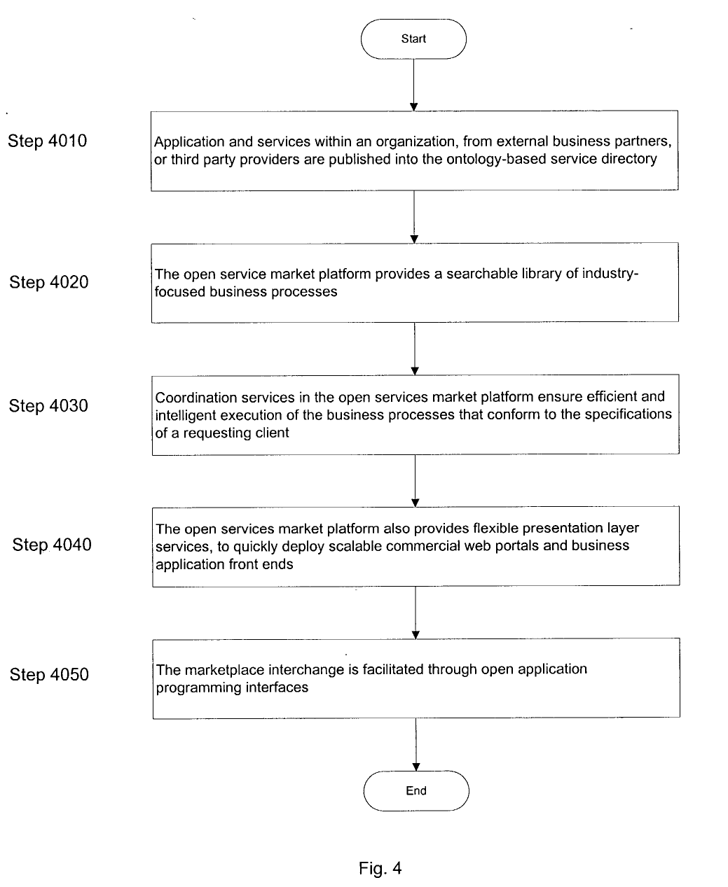

FIG. 4 illustrates interactions within an open services market platform-enabled marketplace. In Step 4010, application and services within an organization, from external business partners or third party providers are published into the ontology-based service directory. The publishing process maps the published application and services to normalize heterogeneous application programming interfaces and information. In Step 4020, open service market platform 100 provides a searchable library of industry-focused business processes. These business processes are composed of sequences of sub-processes and electronic service calls and the processes can be customized to meet the specific needs of individuals or groups within a given marketplace.

In Step 4030, coordination services in platform 100 ensure efficient and intelligent execution of the business processes that conform to the specifications of a requesting client. As needed, service brokers may negotiate to find and contract with appropriate service providers to fulfill business process steps. Other market-oriented mechanisms for coordination decisions may also be able to influence the business process flow. In Step 4040, platform 100 also provides flexible presentation layer services to quickly deploy scalable commercial web portals and business application front ends. This provides end-user access to the open services market-managed services and processes. In Step 4050, the marketplace interchange is facilitated through open application programming interfaces that enable dynamic discovery and inspection of the services, processes, and protocols of interaction for those resources.

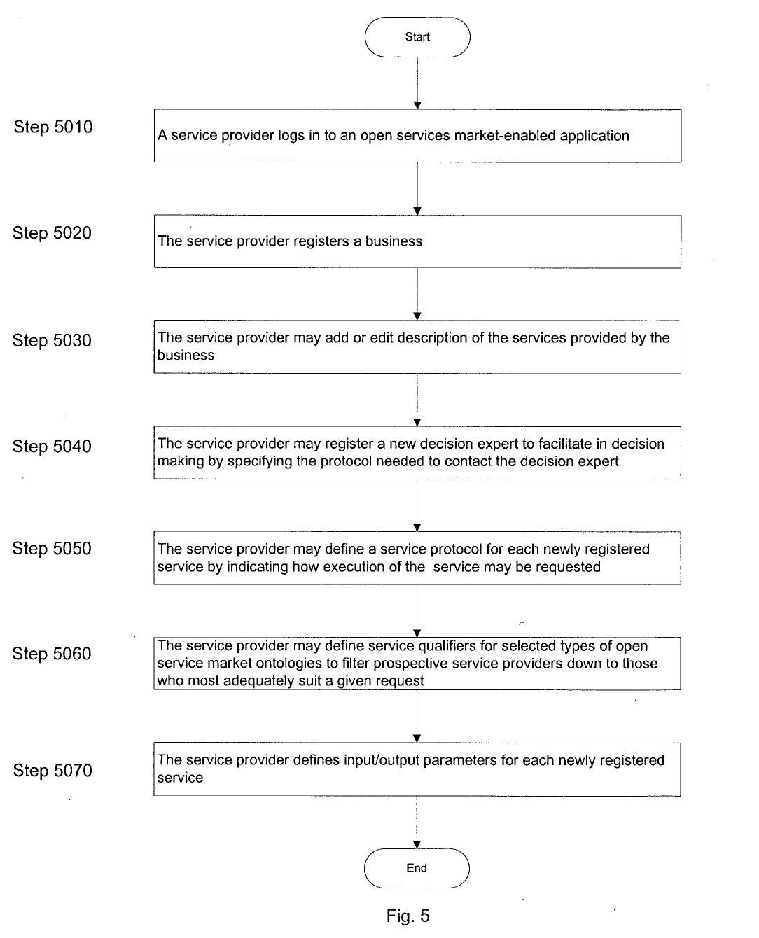

FIG. 5 illustrates how services are defined and published in the open services market platform 100. In Step 5010, a service provider logs in to an open services market-enabled application. In Step 5020, the service provider registers a business by entering identifying information, such as a business name, contact information, home page URL, description, and tax identifier. In Step 5030, the service provider may add or edit description of the services provided by the business. The service provider may also register an instance of a service from among the service types listed in the service ontology library. Services provided by a business are attached to the service provider's registration record.

In Step 5040, the service provider may register a new decision expert to facilitate in decision making by specifying the protocol needed to contact the decision expert. In Step 5050, service provider may define a service protocol for each newly registered service by indicating how execution of the service may be requested. In Step 5060, the service provider may define service qualifiers for selected types of open service market ontologies to filter prospective service providers down to those who most adequately suit a given request. For example, a service qualifier for a shipping service might be “will ship hazardous materials.” In Step 5070, the service provider defines input/output parameters for each newly registered service. If the service provider provides an application programming interface that does not correspond to a specific marketplace, the open services market service publisher provides a mapping tool that facilitates integration between the marketplace and the service provider.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A system for creating an electronic marketplace that enables inter-enterprise collaboration, integration and customization and accelerates system development, the system comprises:
an open services market platform that comprises:
a collaboration layer having a common language and components for defining relationships among various programming interfaces and formats and enabling dynamic addition and editing of participants and services in the electronic marketplace;
a service coordination layer having components for enabling rapid customization of business logic and automating brokering and service coordination among participants in the electronic marketplace; and
a plurality of server level components that interface with the collaboration layer and the service coordination layer to deliver functions and services to participants of the electronic marketplace.

2. The system of claim 1, wherein the collaboration layer comprises:
business service vocabularies that provide trading partners in the electronic marketplace with an ontology-based language for rapid integration of services and effective negotiation and collaboration among trading partners and services;
mapping tools that enables the trading partners to define relationships among various application programming interfaces and information formats; and
a registry that enables dynamic addition and editing of trading partners and services in the electronic marketplace.

3. The system of claim 1, wherein the service coordination layer comprises:
a business process engine that enables rapid customization of business logic in the electronic marketplace and;
a brokering and service coordination tool that facilitates in selecting at least one optimal trading partner.

4. The system of claim 3, wherein the brokering and service coordination tool uses customized business rules and domain-specific knowledge that are predefined in the electronic marketplace to facilitate in the selection of at least one optimal trading partner.

5 The system of claim 1, wherein the plurality of server level components are arranged in a hierarchical fashion, whereby each layer in the hierarchy is implemented using a predefined interface.

6 The system of claim 5, wherein the plurality of server level components comprise:
a presentation layer that manages user interfaces in the electronic marketplace and users' interactions with the user interfaces;
a business logic layer that defines the functionality of a business application in the electronic marketplace and specifies how individual functional components of the business application communicate with external services; and
a services layer that provides mediated access to potentially distributed services across numerous communication protocols.

7. The system of claim 6, wherein the presentation layer is used to define the user interfaces in the electronic marketplace, whereby the user interfaces are loosely coupled to business logic implemented in the electronic marketplace.

8. The system of claim 6, wherein the business logic layer implements the functionality behind the user interfaces.

9. The system of claim 8, wherein the business logic layer implements the functionality behind the user interfaces by associating predefined user interactions with the user interface to specific programmed components in the electronic marketplace.

10. The system of claim 8, wherein the business logic layer implements functionality behind the user interfaces by associating predefined user interactions with the user interface to predefined business processes in the electronic marketplace.

11. The system of claim 8, wherein the business logic layer implements the functionality behind the user interfaces by delegating to predefined external services providers execution of events caused by predefined user interactions with the user interface.

12. The system of claim 6, wherein the services layer enables the business logic layer to access and integrate with predefined component services in the electronic marketplace and with external business services.

13. The system of claim 12, wherein the services layer comprises:
an ontology builder that is used to create and modify ontologies through which services, information and processes that are used in the electronic marketplace are structured;
a service registry that is a dynamic directory of web-based services;
a service publisher for enabling providers of on-line commerce to dynamically register and administer descriptions of their capabilities within the electronic marketplace;
a service coordination advisor that encodes a trading partner's logic for how to do business with other trading partners and uses predefined rules and factors to help manage the selection of the at least one optimal trading partner;
a service select wizard that enables a user to specify requirements for selecting an appropriate service provider in the electronic marketplace to accomplish a specific task, thereby enabling implementation of the service coordination advisor; and
a service execution engine that manages communications with remote business services and uses predefined communication protocols to interact with trading partners selected by the service coordination advisor.

14. The system of claim 13, wherein the open services market platform provides at least one data structure for storing information about trading partners, the services performed by each trading partner, constraints and properties associated with each services, and rules for managing the services and relationships between the trading partners.

15. The system of claim 13, wherein the open services market platform provides an initial ontology and tools for creating relationships between the initial ontology and existing standards and application programming interfaces.

16. The system of claim 13, wherein tools in the service publisher maps an application programming interface specification in a preferred format to different marketplaces' formats, thereby enabling a service provider to maintain the application programming interface specification in the preferred format.

17. The system of claim 13, wherein the service coordination advisor uses a decision-theoretic algorithm to combine inputs across multiple dimensions from a potentially distributed set of knowledge sources.

18. The system of claim 13, wherein the service select wizard displays a list of recommended providers supplied by the service coordination advisor.

19. The system of claim 18, wherein the user selects a preferred provider from the list and specifies whether the service coordination advisor should perform a run-time analysis to optimize the selection process.

20. The system of claim 18, wherein the user selects a preferred provider from the list and specifies whether the service coordination advisor should perform an exception handling at run-time.

21. A open-services market-enabled electronic marketplace that enables inter-enterprise collaboration, integration and customization and accelerates system development, the marketplace comprises:
a first component that provides trading partners in the electronic marketplace with an ontology-based language for rapid integration of services and effective negotiation and collaboration among trading partners and services;
a second component that enables the trading partners to define relationships among various application programming interfaces and information formats;
a third component that enables dynamic addition and editing of trading partners and services in the electronic marketplace;
a business process engine that enables rapid customization of business logic in the electronic marketplace;
a fourth component that facilitates in selecting at least one optimal trading partner;
a fifth component that enables rapid customization of business logic and automates brokering and service coordination among participants in the electronic marketplace; and
a plurality of server level components that interface with the first to fifth components to deliver functions and services to participants of the electronic marketplace.

22. A open-services market-enabled electronic marketplace that enables inter-enterprise collaboration, integration and customization and accelerates system development, the marketplace comprises:
a presentation layer for managing user interfaces in the electronic marketplace and users' interactions with the user interfaces;
a business logic layer for defining the functionality of a business application in the electronic marketplace and for specifying how individual functional components of the business application communicate with external services; and
a services layer for providing mediated access to potentially distributed services across numerous communication protocols.

23. The marketplace of claim 22, wherein the business logic layer implements the functionality behind the user interfaces by associating predefined user interactions with the user interface to specific programmed components in the electronic marketplace.

24. The marketplace of claim 22, wherein the business logic layer implements the functionality behind the user interfaces by associating predefined user interactions with the user interface to predefined business processes in the electronic marketplace.

25. The marketplace of claim 22, wherein the business logic layer implements the functionality behind the user interfaces by delegating to predefined external services providers execution of events caused by predefined user interactions with the user interface.

26. A open-services market-enabled electronic marketplace that enables inter-enterprise collaboration, integration and customization and accelerates system development, the marketplace comprises:
a presentation layer that manages user interfaces in the electronic marketplace and users' interactions with the user interfaces;
a business logic layer that defines the functionality of a business application in the electronic marketplace and specifies how individual functional components of the business application communicate with external services;
an ontology builder that is used to create and modify ontologies through which services, information and processes that are used in the electronic marketplace are structured;
a service registry that is a dynamic directory of web-based services;
a service publisher that is a wizard based tool for enabling providers of on-line commerce to dynamically register and administer descriptions of their capabilities within the electronic marketplace;
a service coordination advisor that is rule-based expert system that encodes a trading partner's logic for how to do business with other trading partners and uses predefined rules and factors to help manage the selection of the at least one optimal trading partner;
a service select wizard that is a user interface that enables a user to specify requirements for how an appropriate service provider in the electronic marketplace should be selected to accomplish a specific task, thereby enabling implementation of the service coordination advisor; and
a service execution engine that manages communications with remote business services and uses predefined communication protocols to interact with trading partners selected by the service coordination advisor.

27. A method for facilitating interaction with an open services market-enabled electronic marketplace that enables inter-enterprise collaboration, integration and customization and accelerates system development, the method comprises the steps of:
registering a trading partner with the electronic marketplace;
publishing, by the trading partner, services performed by the trading partner;
mapping published services to application programming interfaces and information;
providing a library of business processes;
ensuring efficient execution of the business process to conform to specifications identified by a requesting participant of the electronic marketplace;
providing services, to the trading partner, to create web portals and business application user interfaces;
providing open application programming interfaces that enable dynamic discovery and inspection of services in the electronic marketplace; and
providing protocols for interaction with services in the electronic marketplace.
